(19) United States
(12) Patent Application Publication
(10) Pub. No.: US 2018/0367491 A1
(43) Pub. Date: Dec. 20, 2018

(54) FOLLOW-UP QUEUE FOR MOBILE DEVICE NOTIFICATIONS

(71) Applicant: Motorola Mobility LLC, Chicago, IL (US)

(72) Inventors: Amit Kumar Agrawal, Bangalore (IN); Sharad Joshi, Schaumburg, IL (US)

(21) Appl. No.: 15/625,442

(22) Filed: Jun. 16, 2017

(51) Int. Cl. H04L 12/58; H04W 4/12

(52) U.S. Cl. CPC H04L 51/24; H04W 52/0209; H04W 4/12

(57) ABSTRACT

A method includes displaying a notification list including a plurality of notifications associated with applications on a display of a mobile device and adding a selected notification in the notification list to a follow-up queue in the device responsive to receiving a first user input associated with the selected notification.

### BACKGROUND

### Field of the Disclosure

The disclosed subject matter relates generally to mobile computing systems and, more particularly, to generating a follow-up queue from a list of notifications.

### Description of the Related Art

Mobile devices include displays that also function as touch sensitive user interfaces. In some applications, a low power, always-on display (AoD) mode is employed to display notifications to a user, such as missed calls, voice mails, incoming messages, etc. While the AoD informs the user of the notifications, to interact with the applications associated with the notifications, a user must unlock the device, thereby exiting the low power mode. Although mobile device displays have increased in size, it is difficult for a user to readily view a long list of notifications. As a result, a user may just skim over the notification list or clear the notification list without reviewing all of the notifications. In some cases, notifications may be bundled into groups according to the application that generated the notification. If a user selects a bundle, the associated application is opened and the notifications are removed from the notification list. The user may not have time to review all of the events in the bundle at that particular time, but since they are all removed when the application is launched, they cannot be viewed at a later time in the notification list. Any of these scenarios may potentially result in the user missing an important or useful notification.

The present disclosure is directed to various methods and devices that may solve or at least reduce some of the problems identified above.

### BRIEF DESCRIPTION OF THE DRAWINGS

The present disclosure may be better understood, and its numerous features and advantages made apparent to those skilled in the art by referencing the accompanying drawings.

FIG. 1 is a simplified block diagram of a mobile device operable to generate a follow-up queue from a list of notifications generated by the device, according to some embodiments disclosed herein;

FIG. 2 is a simplified flow diagram of a method for generating a follow-up queue from a list of notifications, according to some embodiments disclosed herein; and

FIGS. 3-6 are front views of the device of FIG. 1 illustrating user interaction events for generating the follow-up queue, according to some embodiments disclosed herein.

The use of the same reference symbols in different drawings indicates similar or identical items.

### DETAILED DESCRIPTION OF EMBODIMENT(S)

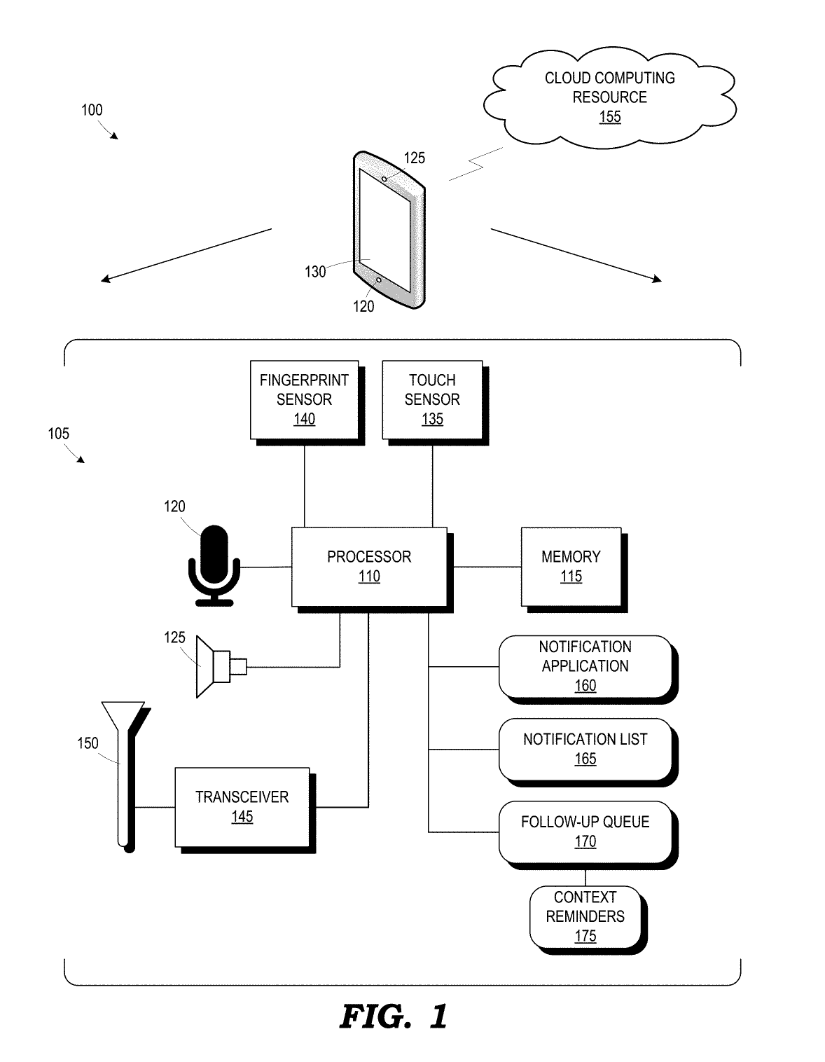

FIGS. 1-6 illustrate example techniques for generating a follow-up queue from a list of notifications. A notification list may be provided on a display of the device, and the user may interact with the notification list using touch or voice commands to generate a follow-up queue. In some instances, automatic reminder timers may be generated for the items entered into the follow-up queue based on context information included in the notification.

FIG. 1 is a simplistic block diagram of a device 100. The device 100 implements a computing system 105 including, among other things, a processor 110, a memory 115, a microphone 120, a speaker 125, a display 130, a touch sensor 135 (e.g., capacitive sensor) associated with the display 130, and a fingerprint sensor 140. The memory 115 may be a volatile memory (e.g., DRAM, SRAM) or a non-volatile memory (e.g., ROM, flash memory, hard disk, etc.). The device 100 includes a transceiver 145 for transmitting and receiving signals via an antenna 150 over a communication link. The transceiver 145 may include one or more radios for communicating according to different radio access technologies, such as cellular, Wi-Fi, Bluetooth®, etc. The communication link may have a variety of forms. In some embodiments, the communication link may be a wireless radio or cellular radio link. The communication link may also communicate over a packet-based communication network, such as the Internet. In one embodiment, a cloud computing resource 155 may interface with the device 100 to implement one or more of the functions described herein.

In various embodiments, the device 100 may be embodied in a handheld or wearable device, such as a laptop computer, a handheld computer, a tablet computer, a mobile device, a telephone, a personal data assistant, a music player, a game device, a wearable computing device and the like. To the extent certain example aspects of the device 100 are not described herein, such example aspects may or may not be included in various embodiments without limiting the spirit and scope of the embodiments of the present application as would be understood by one of skill in the art.

In the device 100, the processor 110 may execute instructions stored in the memory 115 and store information in the memory 115, such as the results of the executed instructions. Some embodiments of the processor 110 and the memory 115 may be configured to implement a notification application 160. The notification application 160 may be implemented as part of an always-on display (AoD) application, which displays a notification list 165 on the display 130 during low power mode operation, and allows the user to interact with the notification list 165 using touch or voice commands to allow the generation of a follow-up queue 170 without exiting the AoD mode. Context reminders 175 (e.g., timers) may be included for entries in the follow-up queue 170 to remind a user regarding designated entries. One or more aspects of the techniques may also be implemented using the cloud computing resource 155 in addition to the notification application 160. Although the following example describes the notification list 165 as being provided in an AoD low power mode, the application of the present subject matter is not limited to an AoD mode. The notification list 165 may be processed by the notification application 160 to generate the follow-up queue 170 in a fully-active mode of the device 100.

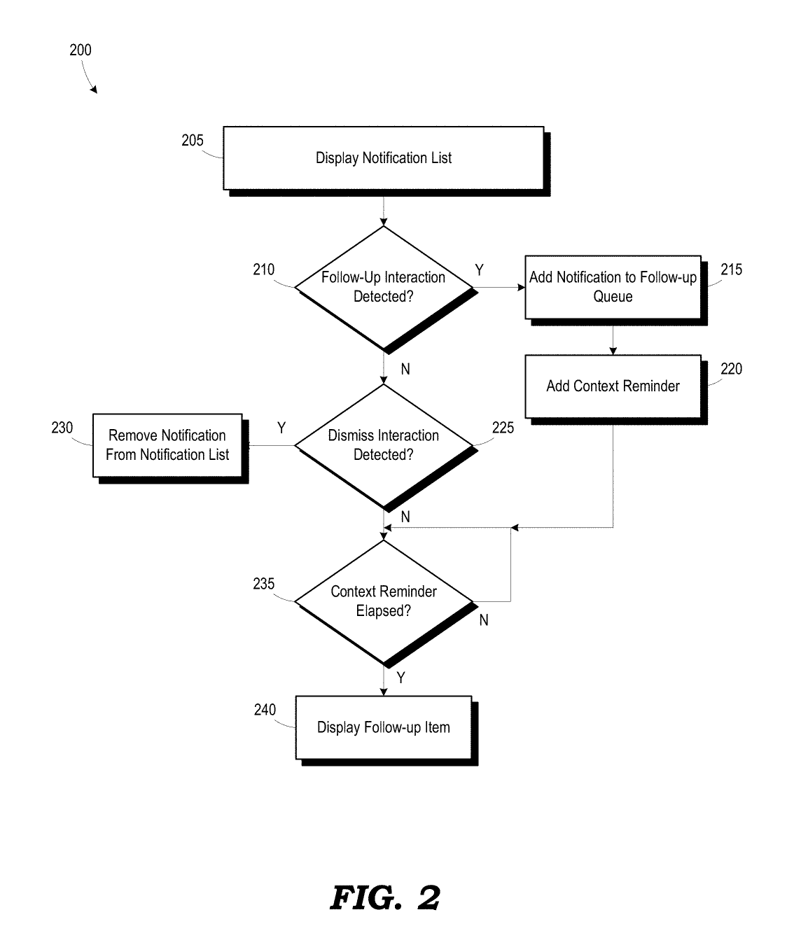

FIG. 2 is a flow diagram of a method 200 for generating a follow-up queue 170 from a list of notifications 165, according to some embodiments disclosed herein. In one example, various elements of the method 200 shown in FIG. 2 may be implemented on the device 100. In some embodiments, the cloud computing resource 155 (see FIG. 1) may also be used to perform one or more elements of the method 200.

In method block 205, a notification list 165 is displayed. Various applications executed by the mobile device 100 may generate notifications, such as the operating system, mail applications, messaging applications, social media applications, telephone applications, etc.

A user may interact with the device 105 in a manner that indicates that a notification should be added to the follow-up queue 170 (e.g., swipe, touch, voice), as described in greater detail below. If a follow-up interaction is detected in method block 210, the selected notification is added to the follow-up queue 170 in method block 215.

In some embodiments, context reminders 175 may be generated for entries in the follow-up queue 170. Based on certain keywords and/or language patterns in the content of the notification, a degree of urgency or time constraint may be identified for the associated notification. For example, the content may mention a particular time or date associated with an event, appointment, delivery, etc. The notification application 160 may determine an appropriate time period (e.g., 1 day, 1 hour, a specific time, etc.) for the notification and generate a context reminder 175 in method block 220. In some embodiments, the user may manually select a reminder timer for the notification entered into the follow-up queue 170 (e.g., by selecting a control on the display 130 or providing a voice command (“remind me in 1 hour”)).

If a follow-up interaction is not detected in method block 210, the method 200 proceeds to determine if a dismiss interaction is detected in method block 225. If a dismiss interaction is detected in method block 225, the selected notification is removed from the notification list 165 in method block 230.

The context reminders 175 are monitored in method block 235. If a context reminder 175 elapses in method block 235, the associated follow-up item is displayed in method block 240. In some embodiments, the follow-up item may be displayed in a separate pop-up window on the display 130, or it may be re-entered into the notification list 165 with a particular formatting that designates it as a follow-up reminder (e.g., icon, color, font type, etc.).

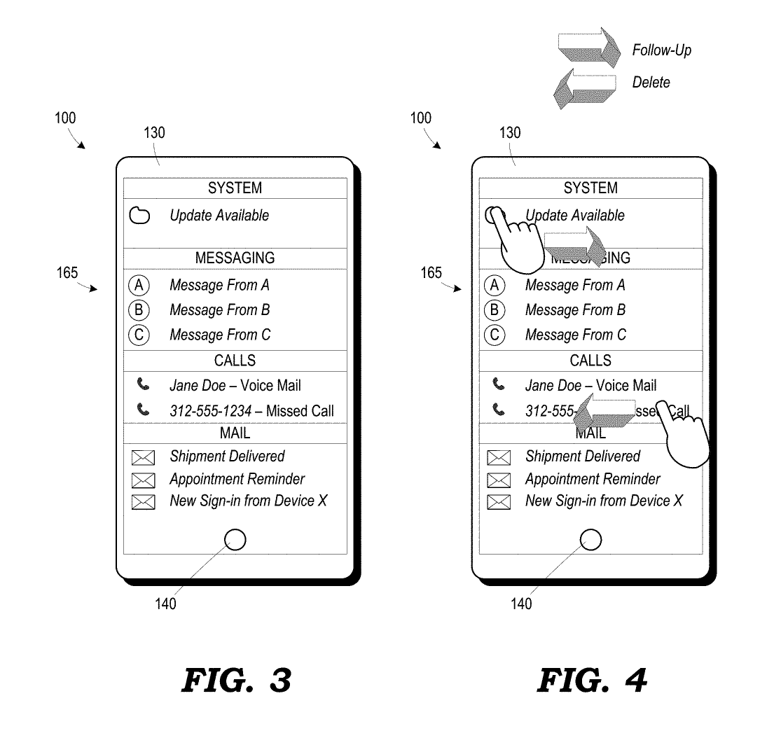

FIGS. 3-6 are front views of the device 100 of FIG. 1 illustrating user interaction events for generating the follow-up queue, according to some embodiments disclosed herein. FIG. 3 illustrates the notification list 165. The notification list 165 may be provided in a low power AoD state, where the device 100 is locked and full functionality is not present. In such a state, the functionality of the device 100 may be limited (e.g., receiving calls or messages, and providing status information on the display 130).

In some embodiments, the notification application 160 may allow the user to interact with the notification list 165 in the locked state. In other embodiments, the notification application 160 may require some authentication by the user to allow interaction with the notification list. In general, the user may interact with the fingerprint sensor 140 to unlock the device 100 and exit the low power state. To provide authentication for interacting with the notification list 165 without exiting the low power state, the notification application 160 may detect a particular interaction with the fingerprint sensor 140 that differs from a conventional unlock touch event. For example, in some embodiments, a time threshold may be employed. If a time interval for the touch event is less than a predetermined interval, the notification application 160 identifies the touch event as an unlock request, and the device 100 is unlocked responsive to authentication of the user's fingerprint. If the time interval for the touch event is greater than the threshold, e.g., a long touch, the notification application 160 allows interaction with the notification list 165 without unlocking the device 100 and exiting the low power mode.

FIG. 4 illustrates swipe events for interacting with the notification list 165. If the user swipes in one direction (e.g., left-to-right), the notification application 160 adds the notification to the follow-up queue 170 (method block 215). If the user swipes in a different direction (e.g., right-to-left), the notification application 160 dismisses the notification (method block 230).

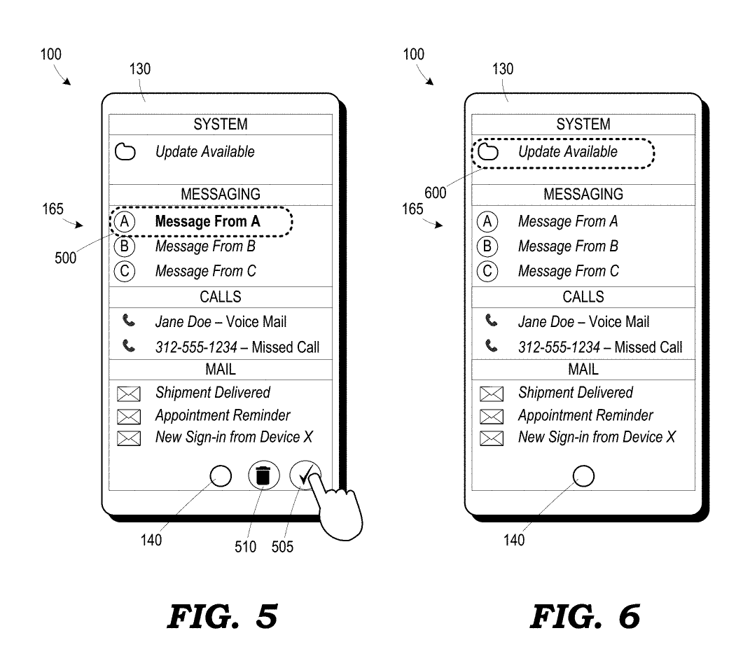

FIG. 5 illustrates touch events for interacting with the notification list 165. A focus indicator 500 may default to the first notification or the user may select a particular notification. If the user touches a follow-up control 505 provided on the display 130, the notification application 160 adds the notification to the follow-up queue 170 (method block 215). If the user touches a dismiss control 510 provided on the display 130, the notification application 160 dismisses the notification (method block 230).

FIG. 6 illustrates voice interactions for interacting with the notification list 165. A user may initiate the interaction with the notification list 165 using a voice command (e.g., “show me notifications”). A focus indicator 600 may default to the first notification or the user may select a notification. The user may employ voice commands to interact with the notifications. If the user says “follow-up” or “dismiss”, the notification application 160 adds the notification to the follow-up queue 170 (method block 215) or dismisses the notification (method block 230), as appropriate.

At some later point in time, the user may return to the follow-up queue 170 to review the items in more detail and take appropriate actions. The user may select a follow-up control or icon on the display 130 or issue a voice command (e.g., “show me follow up”). The follow-up queue 170 display may be similar to the notification list 165 shown in FIG. 3, but only for those items chosen by the user to be placed in the follow-up queue 170. The user may interact with the items in the follow-up queue in a similar manner as described in reference to FIGS. 4-6 (e.g., swipe, touch, or voice to dismiss items). If the user selects a particular follow-up entry, the application that issued the original notification may be opened and the appropriate item associated with the notification may be displayed.

In some embodiments, certain aspects of the techniques described above may be implemented by one or more processors of a processing system executing software. The techniques described herein may be implemented by executing software on a computing device, such as the processor 110 of FIG. 1, however, such methods are not abstract in that they improve the operation of the device 100 and the user's experience when operating the device 100. Prior to execution, the software instructions may be transferred from a non-transitory computer readable storage medium to a memory, such as the memory 115 of FIG. 1.

The software may include one or more sets of executable instructions stored or otherwise tangibly embodied on a non-transitory computer readable storage medium. The software can include the instructions and certain data that, when executed by one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Note that the use of terms, such as “first,” “second,” “third” or “fourth” to describe various processes or structures in this specification and in the attached claims is only used as a shorthand reference to such steps/structures and does not necessarily imply that such steps/structures are performed/formed in that ordered sequence. Of course, depending upon the exact claim language, an ordered sequence of such processes may or may not be required. Accordingly, the protection sought herein is as set forth in the claims below.

1. A method, comprising:
displaying a notification list including plurality of notifications associated with applications on a display of a mobile device;
adding a selected notification in the notification list to a follow-up queue in the device responsive to receiving a first user input associated with the selected notification;
automatically generating a reminder timer for the selected notification in the follow-up queue responsive to the first user input, wherein generating the reminder timer comprises generating the reminder timer based on context information extracted from content of the selected notification and a value of the reminder timer is based on the content; and
displaying the selected notification on the display responsive to the reminder timer expiring.

2. The method of claim 1, wherein the first user input comprises a swipe event.

3. The method of claim 1, wherein the first user input comprises a voice command.

4. The method of claim 1, wherein the first user input comprises a tap event on a follow-up control icon.

5. The method of claim 1, wherein displaying the notification list comprises displaying the notification list on the display in a low-power mode of the device and the first user input is received without the device exiting the low-power mode.

6. (canceled)

7. The method of claim 1, wherein displaying the selected notification comprises generating a new entry in the notification list for the selected notification responsive to the reminder timer expiring.

8. (canceled)

9. The method of claim 1, wherein generating the reminder timer comprises generating the reminder timer based on the first user input.

10. The method of claim 1, wherein adding the selected notification in the plurality of notifications to the follow-up queue further comprises:
adding the selected notification to the follow-up queue in the device responsive to receiving a first user swipe event associated with the selected notification in a first direction; and
deleting a second notification from the notification list responsive to receiving a second user swipe event associated with the second notification in a second direction different than the first direction.

11. A device, comprising:
a display; and
a processor coupled to the display to display a notification list including a plurality of notifications associated with applications executed by the device on the display, add a selected notification in the notification list to a follow-up queue responsive to receiving a first user input associated with the selected notification, automatically generate a reminder timer for the selected notification in the follow-up queue responsive to the first user input, and display the selected notification on the display responsive to the reminder timer expiring, wherein generating the reminder timer comprises generating the reminder timer based on context information extracted from content of the selected notification and a value of the reminder timer is based on the content.

12. The device of claim 11, further comprising a touch sensor associated with the display, wherein the first user input comprises a swipe event on the display.

13. The device of claim 11, wherein the first user input comprises a voice command.

14. The device of claim 11, further comprising a touch sensor associated with the display, wherein the first user input comprises a touch event on a follow-up control icon provided on the display.

15. The device of claim 11, wherein the processor is to display the notification list in a low-power mode of the device and receive the first user input without the device exiting the low-power mode.

16. (canceled)

17. The device of claim 11, wherein the processor is to generate a new entry in the notification list for the selected notification responsive to the reminder timer expiring.

18. (canceled)

19. The device of claim 11, wherein the processor is to generate the reminder timer based on the first user input.

20. The device of claim 11, wherein the processor is to add the selected notification to the follow-up queue in the device responsive to receiving a first user swipe event associated with the selected notification in a first direction and dismiss a second notification from the notification list responsive to receiving a second user swipe event associated with the second notification in a second direction different than the first direction.

21. The method of claim 1, wherein the content comprises a particular time or date associated with the selected notification.

22. The method of claim 11, wherein the content comprises a particular time or date associated with the selected notification.
